(19) United States
(12) Patent Application Publication
(10) Pub. No.: US 2013/0113634 A1
(43) Pub. Date: May 9, 2013

(54) LIGHT EMITTING DIODE ROAD FLARE DEVICE

(71) Applicants: Ronald M. Hutchinson, Brookfield, WI (US); Tush Hse Tsai, Mei Foo Sun Chuen (HK); Conglun Yu, Cixi (CN)

(72) Inventors: Ronald M. Hutchinson, Brookfield, WI (US); Tush Hse Tsai, Mei Foo Sun Chuen (HK); Conglun Yu, Cixi (CN)

(21) Appl. No.: 13/291,877

(22) Filed: Nov. 8, 2011

(51) Int. Cl. G08G 1/0955

(52) U.S. Cl. 340/908

(57) ABSTRACT

An LED road flare device provides an outer protective structure substantially in the form of a box-like rounded triangle. The outer protective structure comprises a first portion, which is a light-transparent enclosure having a plurality of LEDs disposed within it, and a second portion, which is a light-opaque resilient overlay comprising a front and rear face, the front and rear face being connected by a plurality of ribs defined at the outer edges of the faces. The LEDs are mounted within the transparent enclosure such that they are positioned between the ribs of the first portion to and are visible from outside the device. Electronic circuitry is provided to vary the lighting sequence of the LEDs when activated. A self-contained power supply is disposed within the transparent enclosure and means for recharging the power supply is also provided. Alternative embodiments include structure for supplemental stabilization of the device.

### FIELD OF THE INVENTION

This invention relates generally to electronic devices that use electroluminescence or light-emitting diode (or “LED”) technology. It also relates, very generally, to incendiary road flares of the type that are used to alert drivers of a hazardous road condition. More specifically, the present invention relates to a uniquely-configured and uniquely-shaped LED road flare device, namely, an electronic road flare that is fabricated as a substantially triangular-shaped box-like structure which can be used primarily and preferably in a vertical or upright position for traffic safety or advance warning purposes. The device of the present invention can also be used for a wide variety of other safety and marking applications where a lighted warning device is required or desired.

### BACKGROUND OF THE INVENTION

Night time marking is necessary in a wide variety of hazardous road situations. The most basic type of prior art road marking has been the use of incendiary road flares that are based on pyrotechnic technology and produce an extremely bright light that can be observed from a substantial distance. The drawback of incendiary road flares is that the flare, though bright, is short-lived. The life of a typical road flare, once lit, is only about 10 to 20 minutes. In applications where a road flare is needed to indicate obstacles or to advise caution on roadways at night, multiple flares are likely used until the obstacle or hazard is cleared. Further, the hazard can last well beyond 10 to 20 minutes, and even hours, depending on the severity of the situation to be cleared.

In the experience of these inventors, there have been some attempts to develop electromechanical and electronic devices that simulate an incendiary road flare while making the device last longer. In the view of these inventors, however, the prior art devices that are intended to replace incendiary road flares have shortcomings. For example, some prior art devices are not as visible as traditional road flares. Others are cannot be easily positioned such that the electronic light-emitting counterpart is easily visualized by drivers. Still others are not quickly and easily dispersed at the scene of a vehicular or road hazard. Further, the shapes of other prior art devices do not allow them to be positioned in a stable vertical or upright position which can be critical in the advance warning of such a vehicular or road hazard.

Accordingly, it is an objective of the present invention to provide a highly visible electronic road flare device that is highly visible, is quickly and easily used when such is required and is inherently stable when placed in a vertical or upright position due to its substantially triangular-shaped and box-like construction. It is a further objective to provide such a device that is weather resistant and re-usable. It is yet another objective to provide such a device that has a self-contained and re-chargable power supply built into the device. The road flare device of the present invention has met these objectives.

### SUMMARY OF THE INVENTION

The road flare device of the present invention provides an outer protective structure that is fabricated substantially in the shape of a box-like triangle having slightly rounded sides or edges. This triangular shape is critical to the intended functionality of providing a highly stable device during use. The outer protective structure comprises a number of elements. A first element is a light-transparent enclosure having the similar triangular box-like configuration with slightly rounded edges. The triangular box-like enclosure comprises a primary hollow portion and a secondary cover portion. In the preferred embodiment, the primary hollow portion of the enclosure and the secondary cover portion are attachable to one another in a sealing and water-resistant fashion which protects electronic circuitry contained within the substantially triangular box-like enclosure.

The outer protective structure further comprises a second element which is a shock-absorbing and substantially light-opaque outer structure. The outer structure assumes the same substantially triangular shape of the light-transparent enclosure and effectively envelops a substantial portion of that box-like enclosure, but does not cover it completely. That is, the outer structure must be configured to allow light to pass out of the light-transparent enclosure. To that end, the outer structure further comprises a plurality of ribs that are positioned about the perimeter and along the slightly curved edges of the device. The ribs are separated from one another by spaces between adjacent ribs. In the device of the present invention, the ribs include tubular portions which further provide a means for suspending the device or supporting the device in a vertical or upright position using auxiliary support members, if necessary.

Significantly, each rib is also positioned between adjacent light-emitting diodes (or “LEDs”) that are located in an array within the enclosure. The spaces between the ribs are located at the point of each LED. In this way, the LEDs are visible from outside the device and between each rib. In the view of these inventors, the substantially triangular shape of the device of the present invention is novel because it effectively positions the LEDs in such a way that each side of the device has a number of LEDs facing outwardly. In this fashion, the emitted light from the LEDs is effectively concentrated at each side or edge of the device. This, in the view of these inventors, results in a substantially more visible, and highly visible, configuration than that of the prior art.

The interior of the enclosure comprises support members for holding and supporting a printed circuit board (or “PCB”) within the enclosure. The PCB comprises a flat member having a peripheral edge. A number of LEDs are positioned, wired and secured at the peripheral edge of the PCB. The PCB is similarly configured in a generally triangular shape so as to position the LEDs in a way that makes them highly visible relative to the sides of the device, as described above. The PCB comprises circuitry for actuating each LED in accordance with a pre-programmed scheme which will be apparent later in the detailed description. The PCB of the device of the present invention further comprises an actuation switch and an electric battery.

When assembled for use, the device comprises a substantially triangular front face, a substantially triangular rear face and an outer edge. The outer edge comprises three slightly curved sides, adjacent sides being connected by a substantially more curved corner. The overall rounded triangular shape of the device makes it highly stable when placed in the vertical or upright position and prevents it from rolling away when placed on a sloped surface. Other structural features comprise means for charging the battery, means for ensuring that the device is properly aligned for charging and means for attaching the device to a metallic surface via a magnet.

In application, the LED road flare device of the present invention can be actuated to illuminate the LEDs and to provide a variable and operational lighting sequence. As previously alluded to, that lighting sequence is variable in accordance with a pre-programmed scheme. The device can be placed flat on the ground with one face facing upwardly and the edges being in the vertical position. In the preferred use of the device, however, the device stands vertically and in an upright position. The device is inherently stable in that vertical and upright position due to the substantially triangular shape of the device and its slightly arced sides or edges. In another alternative embodiment, supplemental structure can be used with the device to ensure even more stable stationary and upright placement of the road flare device as may be needed in a specific application.

The foregoing and other features of the substantially triangular-shaped LED road flare device of the present invention will be apparent from the detailed description that follows.

### BRIEF DESCRIPTION OF THE DRAWINGS

FIG. 1 is a top, front and left side perspective view of the substantially triangular-shaped LED road flare device that is constructed in accordance with the present invention.

FIG. 2 is an exploded view of the LED road flare device that is shown in FIG. 1.

FIG. 3 is a slightly enlarged front elevational view of the LED road flare device shown in FIGS. 1 and 2.

FIG. 4 is a view similar to FIG. 1 but illustrating the use of supplemental stabilization elements with the LED road flare device of the present invention.

FIG. 5 is a view similar to FIG. 3 but illustrating a rear elevational view of the LED road flare device.

FIG. 6 is a top plan view of a recharging pad for use with the LED road flare device.

### DETAILED DESCRIPTION

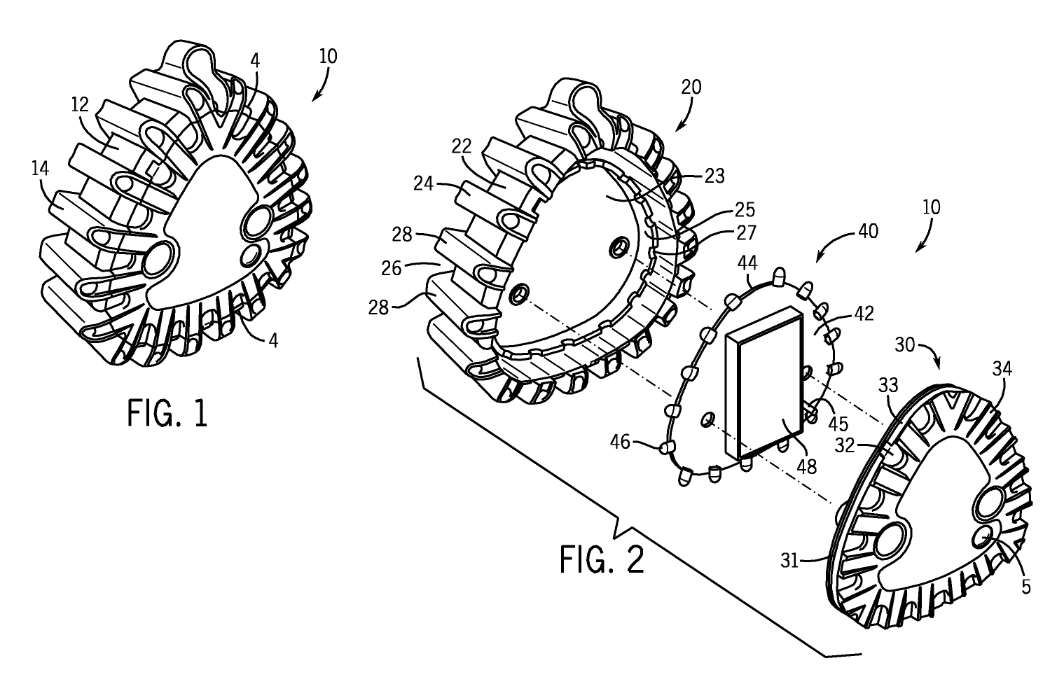

Referring now to the drawings in detail wherein like numbers represent like elements throughout, FIG. 1 illustrates a perspective view of the LED road flare device, generally identified 10, that is constructed in accordance with the present invention. Although the device 10 is identified throughout as an LED “road” flare device, it is to be understood that the device 10 may be easily used in non-vehicular applications and non-traffic hazard situations.

As shown, the LED road flare device 10 is configured as an outer protective structure 12 that is fabricated substantially in the shape of a triangular box having rounded edges. The device 10 is further configured with an overwrap structure 14 that covers a portion of the outer protective structure 12. The outer protective structure 12 comprises a number of elements and the overwrap structure 14 comprises a number of elements as well.

A first element of the outer protective structure 12 is a substantially triangular-shaped base-like housing portion 20. A second element is a substantially triangular-shaped door-like access cover portion 30. See FIG. 2. The door-like access cover portion 30 is configured to be sealingly engaged with the base-like housing portion 20. Novel is the fact that the housing portion 20 and the cover portion 30 each assumes the substantially triangular shape, which aids in the stability of the device 10 during use. A circumferential O-ring 31 is placed about the perimeter 33 of the cover portion 30 to make the device 10 substantially weather resistant when the cover portion 30 engages the housing portion 20.

Further, the housing portion 20 and the cover portion 30 each has a light-transparent element 22, 32 and a light-opaque overwrap 24, 34, respectively. The overwrap 24, 34 allows light to pass outwardly from within the housing portion 20 and through gaps 26 formed between resilient rib-like tubes 28 in the overwrap 24. The overwrap 24, 34 is configured as a resilient plastic material whereas the light-transparent elements 22, 32 are configured as a hard plastic material.

The light-transparent element 22 of the housing portion 20 comprises an interior cavity 23. The cavity 23 comprises means for holding and supporting a printed circuit board (or “PCB”) 40 within it. The PCB 40 comprises a flat member 42 having a substantially triangular shape and a peripheral edge 44. A number of light emitting diodes (or “LEDs”) 46 are positioned, wired and secured at this peripheral edge 44 of the PCB 40. As shown in the preferred embodiment, each side 4 of the device 10 has five (5) LEDs, which increases the intensity of light projected through and from that side 4, which also increases the visibility of the device 10, particularly at night. See FIG. 1.

The PCB 40 comprises electronic circuitry of conventional manufacture for actuating each LED 46 in accordance with a pre-programmed scheme which will be apparent later in the detailed description. The PCB 40 of the device 10 of the present invention further comprises an actuation switch 45 and an electric battery 48. Means for re-charging the battery 48 is also provided, as will be apparent later in this detailed description. Within the interior cavity 23 of the housing portion 20 is a wall-like support structure 25 having a plurality of arcuate grooves 27 defined in it. Each groove 27 is functionally adapted to provide a receiving slot for an LED 46 of the PCB 40.

As previously alluded to, the housing portion 20 and the cover portion 30 are attachable to one another in a sealing and water-resistant fashion which protects the electronic circuitry of the PCB 40 contained therein. The exterior of the device 10 comprises the shock-absorbing and substantially light-opaque overwrap 24, 34 having a plurality of tube-like ribs 38 about the perimeter of the device 10. Each rib 38 is disposed between adjacent LEDs 46 that are located within the device 10, and vice versa. In this way, the LEDs 46 are visible from outside the device 10. The ribs 38 are tubular such that they further provide a means for suspending the device 10 or supporting the device 10 in an upright position using optional stick-like support members 50, as shown in FIG. 4.

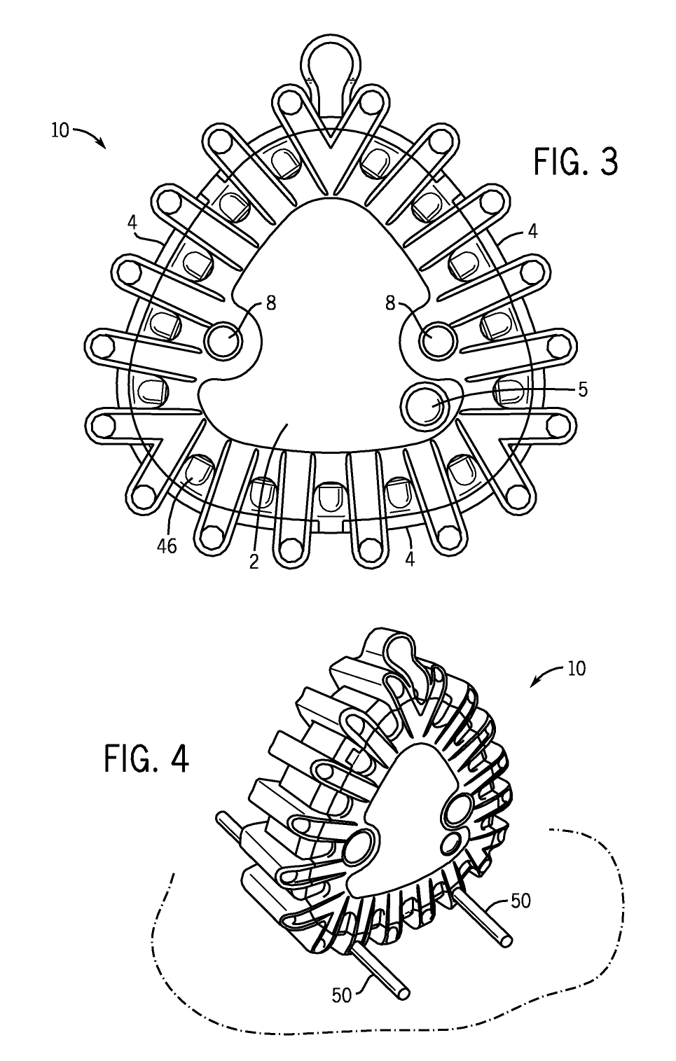

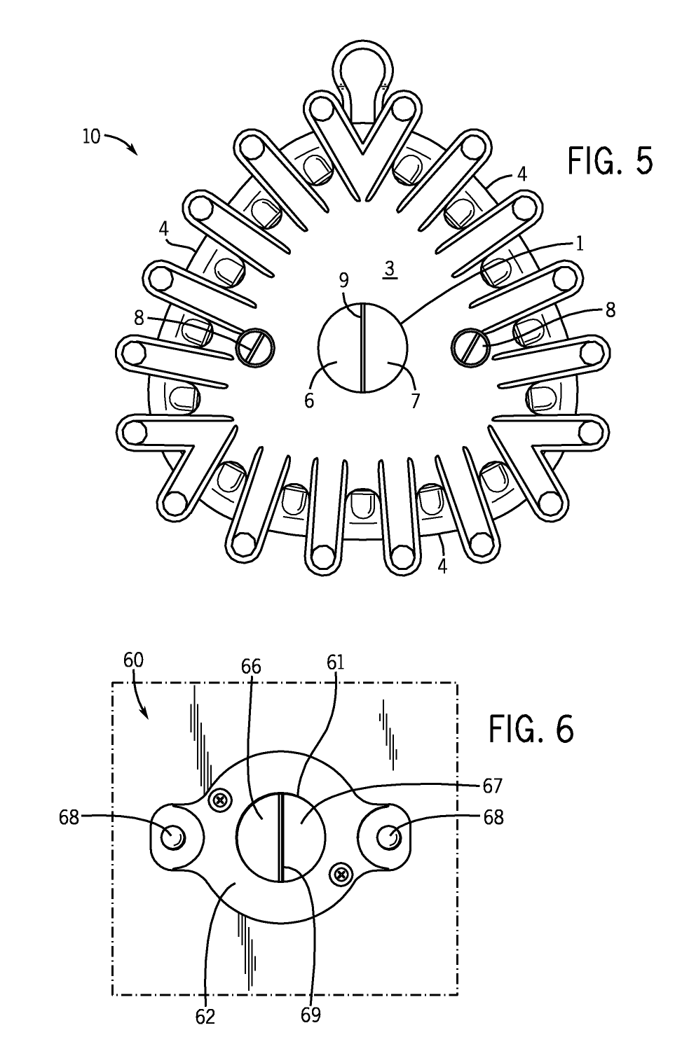

When assembled, the device 10 comprises a triangular-shaped front face 2, a triangular-shaped rear face 3 and three (3) very slightly arced sides 4. See FIGS. 1 and 5. The slightly arced sides 4 are configured to form an overall rounded but substantially triangular shape which is a significant and novel feature of the device 10 of the present invention. In this triangular shape, the device 10 is prevented from rolling away or tipping over when placed on a sloped or uneven surface. See FIG. 3. With the use of the optional support members 50, the device 10 is further prevented from falling face-first forwardly or backwardly. See FIG. 4. This functionality results in a much more stable device 10 when used as intended. Further, as explained above, the concentration of LEDs 46 to one of the three (3) sides 14 of the device 10 greatly increases visibility of the device 10.

The triangular-shaped front face 2 is further provided with a push button 5 which allows the PCB 40 of the device 10 to be electrically actuated. Internally, the push button 5 is aligned with the actuation switch 45 of the PCB 40. See FIG. 2. Externally, the push button 5 forms a continuous surface with the overwrap 34 of the triangular-shaped front face 2. This keeps the device 10 and its contents safe from exposure to rain, snow, dust and the like. The push button 5 actuates the LEDs 46 in various pre-programmed sequences as will be apparent.

The triangular-shaped front face 2 is further provided with pads 8 for charging the battery 48 of the device 10. Another structural feature comprises means for attaching the device 10 to a metallic surface via a magnet 1 that is disposed to the rear face 3 of the device 10. Further, the device 10 comprises means for ensuring that the device 10 is properly aligned for charging. Specifically, as shown in FIG. 5, the device 10 comprises a split magnet 1 having two magnetic pole halves. One magnet half 6 has a first polarity and one magnet half 7 has a second opposite polarity. The halves 6, 7 are separated by a partition 9 and are disposed to the rear face 3 of the device 10 which ensures that the device 10 is properly positioned for recharging via a charging unit 60, such as that shown in FIG. 6, for example. The charging unit 60 comprises a base 62 and a similar split magnet 61 having two magnetic pole halves, one half 66 with a first polarity and one half 67 with a second opposite polarity, the halves 66, 67 being separated by a partition 69. The charging unit 60 further comprises base pads 68. If the rear face 1 of the device 10 is not positioned properly atop the base 62, the magnet halves 6, 7, 66, 67 will repel one another, requiring rotation of the device 10 by 180° for proper charging. If the device 10 is positioned properly, the magnet halves 6, 7, 66, 67 will attract one another, resulting in a successful recharging connection made between the flare pads 8 and the base pads 68.

In application, the LED road flare device 10 of the present invention can be actuated to illuminate the LEDs 46 and to provide an operational lighting sequence. As previously alluded to, that sequence is preferably pre-programmed and variable. That is, the preprogrammed lighting sequence residing within the electronic circuitry can be used to selectively alternate the lighting sequences of the LEDs 46. In the device 10 of the preferred embodiment, the push button 5 is depressed a first time which will actuate the LEDs 46 in a first way. Subsequent depression of the button 5 by the user can change the lighting sequences in one or more of the following ways:

where all of the LEDs 46 are “on;”

where all of the LEDs 46 are “off” (which can also be considered the storage or non-use mode for the device 10);

where the LEDs 46 to one side 4 of the device 10 are “on” and the LEDs 46 to the other two sides 4 of the device 10 are “off;”

where the light from the LEDs 46 rotates about the device 10 in a pattern such that the lights appear to be chasing each other (which can also be considered an alternating and sequential lighting mode);

where all of the LEDs 46 blink “on” a number of times in quick succession;

where all even numbered LEDs 46 blink “on” and then “off,” alternating with all odd numbered LEDs 46 that blink “off” and then “on,” and vice versa;

where all of the LEDs 46 sequentially blink “on” and then “off” in a pattern where three (3) adjacent LEDs 46 to one side 4 of the device 10 blink “on” followed by the next set of two (2) adjacent LEDs 46 which is then repeated along the two (2) other sides 4 of the device 10;

where the LEDs 46 blink in accordance with the Morse code distress signal; and

where the relative brightness of the LEDs 46 can be sequenced to vary the intensity of the emitted light.

In this fashion, any number of pre-programmed lighting sequences can be accessed by the user as he or she depresses the button 5 in succession. The last depression of the button 5 would, preferably, turn off the power to the LEDs 46. Reactivation of the sequence is initiated when next the button 5 is depressed by the user. It is also to be appreciated that the LED road flare device 10 of the present invention can be used for several hours before the battery 48 requires re-charging which greatly promotes the safety of the user for substantially longer times than conventional road flares would allow.

In any of its activated modes, the LED road flare device 10 can be placed flat on the ground with one face 2 facing upwardly. Alternatively, and in the preferred use mode, the device 10 can stand vertically and is stabilized in that position due to the substantially triangular shape of the device 10. In another alternative use mode, the addition of supplemental structure, such as the optional support members 50, results in a much more stable device 10 when used as intended and ensures stable stationary and upright placement of the LED road flare device 10 as needed. Lastly, the substantially triangular shape of the LED road flare device 10 of the present invention is novel because it effectively positions the LEDs 46 in such a way that each side 4 of the device 10 has a number of LEDs 46 facing outwardly. In this fashion, the emitted light from the LEDs 46 is effectively concentrated at each side 4 or edge of the device 10. This, in the view of these inventors, results in a substantially more visible, and highly visible, configuration than that taught by the prior art.

The details of the invention having been disclosed in accordance with the foregoing, we claim:

1. A light-emitting diode flare device comprising:
an outer protective structure configured substantially in the shape of a box-like triangle and formed from a light-transparent material, the outer protective structure further forming an interior cavity and three sides;
an overwrap structure that covers a portion of the outer protective structure, the overwrap structure formed of a light-opaque material;
a printed circuit board disposed within the interior cavity of the outer protective structure, the printed circuit board comprising electronic circuitry and having a peripheral edge;
a plurality of light-emitting diodes disposed about the peripheral edge of the printed circuit board and being electrically connected with the electronic circuitry of the printed circuit board;
a battery disposed within the interior cavity of the outer protective structure and being electrically connected to the electronic circuitry of the printed circuit board and to the plurality of light-emitting diodes; and
an actuation means for selectively turning the electronic circuitry and the light-emitting diodes on and off;
wherein the light-emitting diodes disposed along each side of the outer protective structure increase the intensity of light projected from that side of the device and increase the visibility of the device; and
wherein the device is inherently stable when placed in a vertical position and resting on one of its three sides.

2. The flare device of claim 1 further comprising a preprogrammed lighting sequence residing within the electronic circuitry to selectively alternate the lighting sequences of the light-emitting diodes.

3. The flare device of claim 1 wherein the outer protective structure and the overwrap structure comprise a base-like housing portion and a door-like access cover portion, the door-like access cover portion being configured to be sealingly engaged with the base-like housing portion.

4. The flare device of claim 3 wherein the door-like access cover portion comprises a perimeter and a circumferential O-ring is placed about the perimeter of the cover portion.

5. The flare device of claim 1 wherein the outer protective structure is configured as a hard plastic material.

6. The flare device of claim 1 wherein the overwrap structure is configured as a resilient plastic material.

7. The flare device of claim 6 wherein the overwrap structure further comprises gaps formed between resilient rib-like tubes disposed about the outer protective structure.

8. The flare device of claim 7 further comprising at least one rod-like support member wherein the at least one rod-like support member is insertable into a rib-like tube of the overwrap to stabilize the device when the device is placed in a vertical position.

9. The flare device of claim 2 wherein the preprogrammed lighting sequence residing within the electronic circuitry to selectively alternate the lighting sequences of the light-emitting diodes comprises one or more from a group consisting of:
all light-emitting diodes are on;
all light-emitting diodes are off;
light-emitting diodes to one side of the device are on;
the light-emitting diodes rotate about the device in a chase pattern;
all light-emitting diodes blink on a number of times in quick succession;
all even numbered light-emitting diodes blink on and off, alternating with all odd numbered light-emitting diodes that blink off and on;
the light-emitting diodes sequentially blink on and then off in a pattern where three adjacent light-emitting diodes to one side of the device blink on followed by the next set of two adjacent light-emitting diodes which is repeated along the two other sides of the device;
the light-emitting diodes blink in accordance with the Morse code distress signal; and
the relative brightness of the light-emitting diodes can be sequenced to vary the intensity of the emitted light.

10. The flare device of claim 1 further comprising battery recharge pads disposed to one face of the device and wherein the battery is rechargeable.

11. The flare device of claim 10 further comprising means for properly aligning the device for recharging.

12. A light-emitting diode flare device comprising:
a substantially triangular-shaped front face;
a substantially triangular-shaped rear face;
three sides extending between the front and rear faces;
the front face, the rear face and the three sides being formed of a light-transparent material and forming an interior cavity;
an overwrap structure that covers a portion of the front face, the rear face and the three sides, the overwrap structure formed of a light-opaque material;
a printed circuit board disposed within the interior cavity and comprising electronic circuitry and a peripheral edge;
a plurality of light-emitting diodes disposed about the peripheral edge of the printed circuit board and being electrically connected with the electronic circuitry of the printed circuit board;
a battery disposed within the interior cavity and being electrically connected to the electronic circuitry of the printed circuit board and to the plurality of light-emitting diodes; and
an actuation means for selectively turning the electronic circuitry and the light-emitting diodes on and off;
wherein the light-emitting diodes disposed along each side of the outer protective structure increase the intensity of light projected from that side of the device and increase the visibility of the device; and
wherein the device is inherently stable when placed in a vertical position and resting on one of its three sides.

13. The flare device of claim 12 further comprising a preprogrammed lighting sequence residing within the electronic circuitry to selectively alternate the lighting sequences of the light-emitting diodes.

14. The flare device of claim 12 wherein the overwrap structure comprises gaps formed between resilient rib-like tubes disposed along the sides of the device.

15. The flare device of claim 12 further comprising at least one rod-like support member wherein the at least one rod-like support member is insertable into a rib-like tube of the overwrap structure to stabilize the device when the device is placed in a vertical position.

16. The flare device of claim 12 wherein the preprogrammed lighting sequence residing within the electronic circuitry to selectively alternate the lighting sequences of the light-emitting diodes comprises one or more from a group consisting of:
all light-emitting diodes are on;
all light-emitting diodes are off;
light-emitting diodes to one side of the device are on;
the light-emitting diodes rotate about the device in a chase pattern;
all light-emitting diodes blink on a number of times in quick succession;
all even numbered light-emitting diodes blink on and off, alternating with all odd numbered light-emitting diodes that blink off and on;
the light-emitting diodes sequentially blink on and then off in a pattern where three adjacent light-emitting diodes to one side of the device blink on followed by the next set of two adjacent light-emitting diodes which is repeated along the two other sides of the device;
the light-emitting diodes blink in accordance with the Morse code distress signal; and
the relative brightness of the light-emitting diodes can be sequenced to vary the intensity of the emitted light.

17. The flare device of claim 12 further comprising battery recharge pads disposed to one face of the device and wherein the battery is rechargeable.

18. The flare device of claim 17 further comprising means for properly aligning the device for recharging.
